(19) United States
(12) Patent Application Publication
(10) Pub. No.: US 2008/0242283 A1
(43) Pub. Date: Oct. 2, 2008

(54) Methods, Systems and Computer Program Products for Enhancing Communications Services

(75) Inventor: John Ruckart, Atlanta, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/691,076

(22) Filed: Mar. 26, 2007

(51) Int. Cl. H04M 3/42

(52) U.S. Cl. 455/415

(57) ABSTRACT

Embodiments of the present invention provide methods, systems, and/or computer program products for enhancing communication services. In some method embodiments, an originating device of a call transmitted to a communication device is identified and a location of the originating device is determined. An identification of the originating device and the location of the originating device is sent to the communication device.

### FIELD OF THE INVENTION

This invention relates to communications methods, systems and computer program products and, more particularly, to methods, systems and computer program products for enhancing communications services.

### BACKGROUND OF THE INVENTION

The increasing availability of communication devices, networks, systems and technologies has resulted in an increasing availability of additional services and/or enhancements. For example, communication features such as call waiting, voice mail, call blocking, and caller identification have become available from many communication service providers. Some of these features may be popular due to the recognition that it may be desirable to have information about a party from whom a call is received. For example, in some circumstances, a receiving party may not wish to receive a call from one or more specific parties. Additional information may be available through, for example, caller identification, which may provide a call receiver with the number and, in some cases the name of the party to whom that number is registered. A call receiver may benefit from additional information regarding a received call.

### SUMMARY OF THE INVENTION

Embodiments of the present invention provide methods, systems, and/or computer program products for enhancing communication devices. In some method embodiments, a call is received from an originating device into a call receiving device and identification data corresponding to the originating device that initiated the call is determined. Location data corresponding to the originating device is determined and the identification data and the location data are sent to the receiving device. In some embodiments, the location data may be a link to a third party location data provider.

In some embodiments, the location data may be determined by receiving, into the originating device, positioning signals from a positioning system that is configured to transmit signals to the originating device and determining the location data, within the originating device, using the positioning signals.

In some embodiments, geographical data corresponding to the location data is sent to the call receiving device. In some embodiments, the geographical data is configured to be displayed on the call receiving device as a map of a proximate area corresponding to the location data. In further embodiments, the geographical data may be a link to a geographical data server wherein at least one of a plurality of characteristics of the proximate area are selected for display within the call receiving device.

In some embodiments, the location data includes graphical content configured to be displayed on the call receiving device as a map that depicts the geographical location as an icon corresponding to the caller identification data.

Embodiments of the present invention may also be a the computer program product including a computer usable storage medium having computer-readable program code embodied in the medium, the computer readable program code configured such that a call is routed from an originating device to a call receiving device and identification data corresponding to the originating device that initiated the call is determined. Location data corresponding to the originating device is determined and the identification data and the location data are sent to the receiving device.

Embodiments of some systems may include a caller identifier, configured to determine identification data corresponding to an originating device that originates a call to a receiving device and to transmit the identification data to the receiving device. Systems may also include a caller locator, configured to determine a geographical location of the originating device and to transmit the location data to the receiving device.

In some embodiments, the caller locator is further configured to use Global Positioning System (GPS) data to determine the geographical location.

In some embodiments, the caller locator is further configured to receive the geographical location from the originating device, wherein the geographical location is manually provided in the originating device by a user.

In some embodiments, the caller locator is further configured to receive the geographical location from a communication system configured to determine the geographical location using at least one characteristic of a communication between the originating device and the communication system.

In some embodiments, the geographical location includes graphic content configured to be displayed on the receiving device as a map that depicts the geographical location as a caller name, a caller telephone number and location data. In some embodiments, the map includes feature data corresponding to an area proximate to the geographical location, the feature data comprising roads, routes, and landmarks. In some embodiments, the map includes aerial view data from photographic images.

Some embodiments include means for storing the geographical location in a call log in the receiving device.

In some method embodiments, an originating device of a call transmitted to a communication device is identified and a location of the originating device is determined. An identification of the originating device and the location of the originating device is sent to the communication device.

In some embodiments, determining a location includes receiving the location from the originating device, wherein the originating device is configured to receive positioning signals from a positioning system and determine the location responsive to the positioning signals.

Some embodiments include sending, to the communication device, geographical location data corresponding to the location, wherein the geographical location data comprises graphical content configured include a map to be displayed by the communication device, wherein the map includes a plurality of terrestrial features of an area proximate to the location and a position indication corresponding to the location.

Some embodiments include determining a location of the communication device and sending the location of the communication device to the originating device.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram illustrating systems for enhancing communication services according to some embodiments of the present invention.

FIG. 2 is a block diagram illustrating systems for enhancing communication services according to some other embodiments of the present invention.

FIGS. 3A-3C are a top views of a receiving devices according to some embodiments of the present invention.

FIG. 4 is a block diagram illustrating operations for enhancing communication services according to some embodiments of the present invention.

FIG. 5 is a flow diagram illustrating operations for enhancing communication services according to some embodiments of the present invention.

FIG. 6 is a flow diagram illustrating operations for enhancing communication services according to further embodiments of the present invention.

### DETAILED DESCRIPTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” to another element, it can be directly responsive to the other element, or intervening elements may be present. In contrast, when an element is referred to as being “directly responsive” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Some embodiments of the present invention may arise from recognition that it may be desirable to enhance communication services by providing additional information about a caller to a call receiver. In particular, location data corresponding to the call originator may be of particular interest to a party receiving a call. In embodiments of the present invention, a caller identification and a caller location may be provided to a call receiving party.

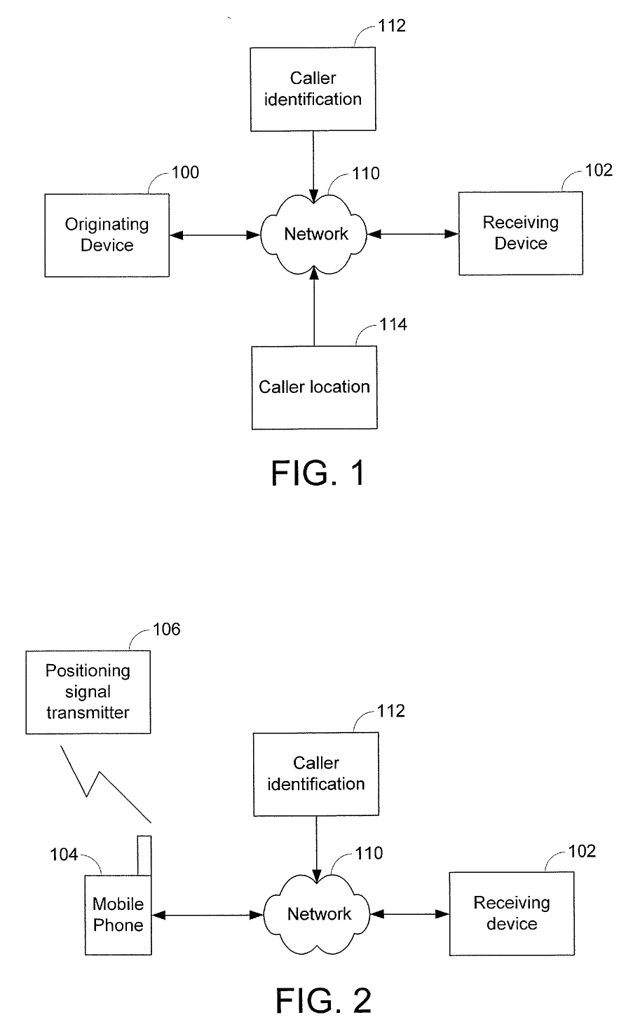

Reference is made to FIG. 1, which is a block diagram illustrating systems for enhancing communication services according to some embodiments of the present invention. An originating device 100 is configured to originate and/or initiate a call to a receiving device 102. The originating device 100 and/or the receiving device 102 may each be any of a variety of wired and/or wireless communication devices, including, for example, a wired telephone, cellular telephone, computer, mobile communication terminal, PDA, and/or paging device, among others. The call may be routed using a network 110 that may include any combination of a variety of communication components and technologies to transmit the call to and from the originating device 100 and the receiving device 102.

A caller identification module 112 may provide identification data corresponding to the originating device 100. Although illustrated external to the network 110 and the originating device 100, the caller identification module 112 may be within the originating device 100 and/or the network 112. The caller identification module 112 may be configured to provide a telephone number of the originating device 100 and/or a name of a party registered with the originating device 100. In some embodiments, a telephone number may be used in conjunction with another internally and/or externally located database to determine the party name.

A caller location module 114 may provide location data corresponding to the originating device 100. The location data may include coordinate data, such as latitude and longitude, address data, and/or premises identification data, such as a name of a commercial entity. The caller location module 114 may be within the originating device 100, the network 110 and/or be implemented external to the network 1 10 and the originating device 100. In some embodiments, the caller location module 114 and the caller identification module 112 may be implemented together in an integrated communication service system. The network 110 may include any combination of a variety of network components, systems, and devices that are capable of providing communication services between the originating device 100 and the receiving device 102. In some embodiments, communication between the originating device 100 and the receiving device 102 may be performed directly between the originating and receiving devices 100, 102 without the network 110.

Reference is now made to FIG. 2, which is a block diagram illustrating systems for enhancing communication services according to some other embodiments of the present invention. A mobile phone 104 is configured to initiate a call to the receiving device 102. The call is routed to the receiving device 102 via a network 110 that is configured to provide communication services between the mobile phone 104 and the receiving device 102.

As used herein, a “mobile phone” may include cellular or other communications devices with or without a multi-line display; Personal Communications System (PCS) terminals that may combine a voice and data processing, facsimile and/or data communications capabilities ; Personal Digital Assistants (PDA) that include a radio frequency receiver and a pager, Internet/Intranet access, Web browser, organizer, calendar and/or a global positioning system (GPS) receiver; and/or other appliances that include a radio frequency transceiver configured to establish a wide-area network connection for voice transmission.

The mobile phone 104 is configured to receive signals from a positioning signal transmitter 106. The positioning signal transmitter 106 may include more than one transmitter that may be satellite and/or terrestrially based. In some embodiments, the positioning signal transmitter 106 is a global positioning system (GPS) transmitter. Responsive to the received position signals, the location of the mobile phone 104 may be determined. In some embodiments, the location may be determined by resolving the position signal within the mobile phone 104. In such embodiments, the location may be transmitted by the mobile phone 104 to the receiving device 102 via the network 110. In some embodiments, the content of the received position signals may be transmitted to an external device for determining the location of the mobile phone 104.

A caller identification module 112 may provide identification data corresponding to the mobile phone 104. Although illustrated external to the network 110 and the mobile phone 104, in some embodiments the caller identification module 112 may be within the mobile phone 104 and/or the network 112. The caller identification module 112 may be configured to provide a telephone number of the mobile phone 104 and/or a name of a party registered with the mobile phone 104. In some embodiments, a telephone number may be used in conjunction with another, internally and/or externally located database to determine the party name.

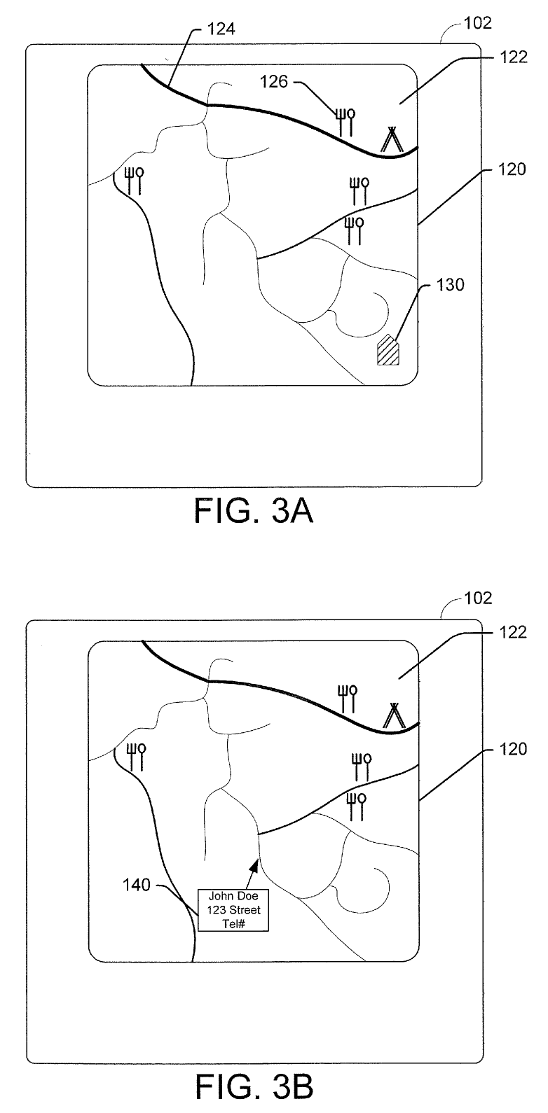

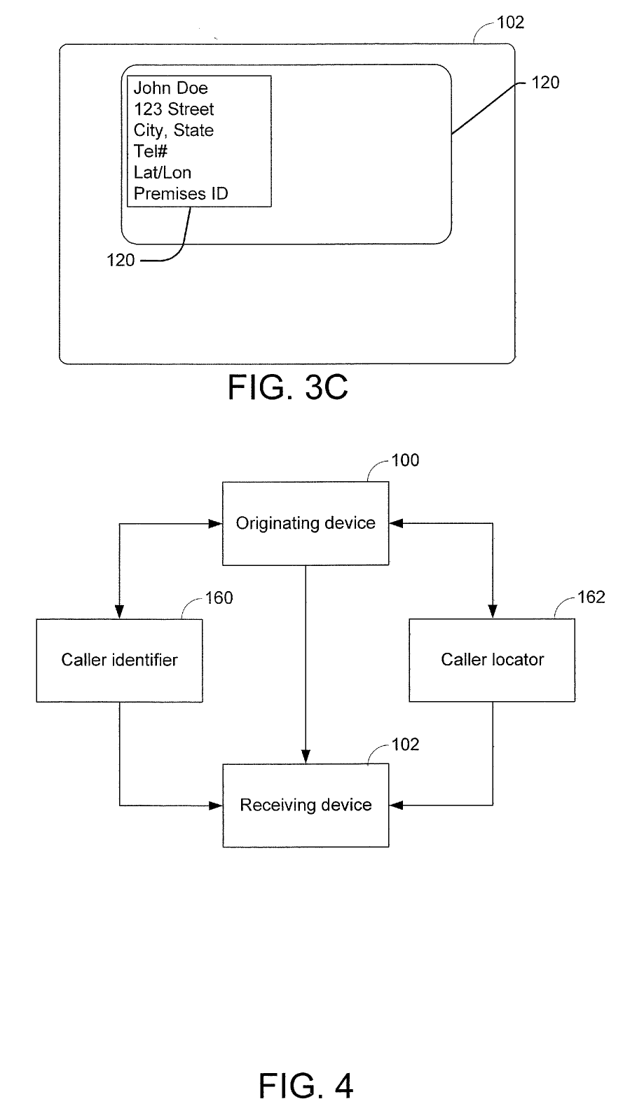

Reference is now made to FIGS. 3A-3C, which are a top views of receiving devices according to some embodiments of the present invention. A receiving device 102 may include a display 120 that is configured to display a variety of types of data, images, and/or video. Referring to FIG. 3A, a display 120 may be configured to display a map 122 that may graphically illustrate a location of the originating device using an icon 130. In some embodiments, the icon 130 may include address data that may include a link to additional data corresponding to the location of the originating device and/or the terrestrial features proximate to the location. In this manner, the receiving device 102 can determine graphically and relative to other terrestrially based features, the location of the call originating and/or initiating device.

The map 122 may illustrate streets 124 and/or other features, such as bodies of water, designated zones, such as shopping centers and parks, and/or government facilities, such as airports. The map 122 may also identify locations of commercial service providers, such as restaurants, fuel stations, hotels, and/or campgrounds using icons 126. For example, a fork and spoon icon may be used to identify a restaurant location.

Referring to FIG. 3B, a map 122 on a display 120 of a receiving device 102 may illustrate the location of the originating device using a location indicator coupled with location information 140, such as name, address and/or street name, telephone number, location coordinates, and/or premises identification. For example, the location information may indicate that the originating device is within the boundaries of a governmental entity, such as, for example, the airport. In some embodiments, the location information may be updated on the map 122 to reflect movement of the originating device during the call. The map 122 may be further enhanced using aerial view data from photographic images. Referring to FIG. 3C, in some embodiments, the location information 150 may be displayed as text without additional graphical content.

Reference is now made to FIG. 4, which is a block diagram illustrating operations for enhancing communication services according to some embodiments of the present invention. An originating device 100 originates a call to a receiving device 102. A caller identifier 160 may provide caller identification information to the receiving device 102. In some embodiments, the caller identifier 160 may be within the originating device 100. In some embodiments, the caller identifier 160 may be integrated into and/or combined with other communications equipment such as, for example, a the call routing device (not shown).

A caller locator 162 is configured to determine a location of the originating device 100 and provide the location to the receiving device 102. In some embodiments, the call, the caller identification, and/or the caller location may be transmitted to the receiving device via one or more routing devices (not shown). In some embodiments, the caller locator 162 may be configured within the originating device 100, such that the originating device 100 determines and communicates its own location to the receiving device 102. In some embodiments, the caller locator 162 is collocated with the caller identifier 160 and/or a call routing device (not shown). In some embodiments, the caller locator 162 may use positioning system signals, such as from a global positioning system (GPS), to determine the location.

In some embodiments, the caller locator 162 may receive a geographical location from the originating device. For example, the geographical location may be entered into the originating device manually by a user. In some embodiments the geographical location may be provided from a communication system that may use one or more characteristics of communication between the originating device and the communication system to determine the geographical location. For example, triangulation techniques using multiple transceivers in a communication system may be used to determine the geographical location.

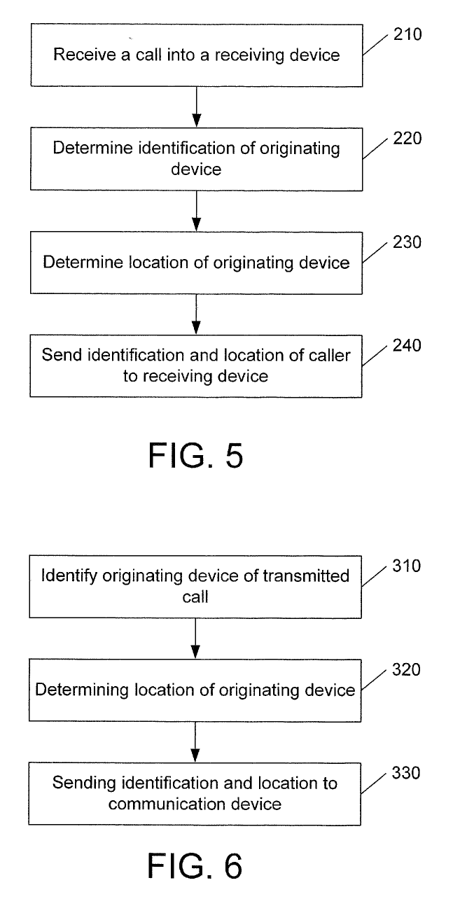

Reference is now made to FIG. 5, which is a flow diagram illustrating operations for enhancing communication services according to some embodiments of the present invention. A call is received from an originating device into a receiving device (block 210). The originating device and the receiving device may each be any of a variety of wired and/or wireless communication devices, including, for example, a wired telephone, cellular telephone, computer, mobile communication terminal, PDA, and/or paging device, among others. In some embodiments, the call may be routed using a communication system and/or network that may include any combination of a variety of communication components and technologies to transmit the call to and from the originating device and the receiving device.

Identification data corresponding to the originating device is determined (block 220). The identification data may be determined within the originating device and/or by a communication system external to the originating device. Location data corresponding to the originating device is determined (block 230). In some embodiments, determining the location data may include receiving, into the originating device, positioning signals from a positioning system and determining the location data responsive to the received positioning signals. Some embodiments may include receiving the location data from an external source, such as a communication network. For example, in some embodiments, an originating device may be registered with and proximate to a local area network (LAN), which may provide the location data. The location data may include location information, such as location coordinates, an address, and/or a premises identification and/or a link and/or network address to a third party location data provider.

The identification and location of the originating device is sent to a receiving device (block 240). In addition to sending the location data to the receiving device, geographical data corresponding to the location data may be sent to the receiving device. For example, a map of an area proximate to the location may be sent to the receiving device. In some embodiments, the geographical data may be displayed on the receiving device as a map of the proximate area. In some embodiments, the geographical data may be a link to a geographical data server such that different characteristics of the proximate area may be selected for display in the receiving device. For example, specific types of features such as accommodations, restaurants, parks, and/or scenic routes may be selectively displayed with the location of the originating device.

The location data may include graphical content configured to be displayed on the call receiving device as an icon. The icon may be displayed on a map of the proximate area. The icon may be caller specific and include graphical content that communicates the identity of the caller, such as, for example, a picture of the caller.

Reference is now made to FIG. 6, which is a flow diagram illustrating operations for enhancing communication services according to further embodiments of the present invention. An identity of an originating device of a call transmitted to a communication device is determined (block 310). A location of the originating device is determined (block 320). In some embodiments, determining the location may include receiving positioning signals into the originating device and determining the location based on the received positioning signals. An identification and location corresponding to the originating device are sent to the communication device (block 330).

In some embodiments, geographical data corresponding to the location may be sent to the communication device. The geographical data may include geographical content that includes graphical content configured to include a map to be displayed on the communication device. In addition to a position indication corresponding to the location, the map may include a variety of terrestrial features of an area proximate to the location. The position indication may be, for example, an icon and/or a pointer that designates a specific location on the map.

Some embodiments may further include determining the location of the communication device and sending the location of the communication device to the originating device. In this manner, the location of each of the communicating device and the originating device may be known to the other.

What is claimed is:

1. A method of enhancing communication services, comprising:
receiving a call from an originating device into a receiving device;
determining identification data corresponding to the originating device that initiated the call;
determining location data corresponding to the originating device; and
sending the identification data and the location data to the receiving device.

2. The method of claim 1, wherein the location data comprises a link to a third party location data provider.

3. The method of claim 1, wherein determining location data comprises:
receiving, into the originating device, positioning signals from a positioning system that is configured to transmit signals to the originating device; and
determining the location data, within the originating device, using the positioning signals.

4. The method of claim 1, further comprising sending geographical data corresponding to the location data to the call receiving device.

5. The method of claim 4, wherein the geographical data is configured to be displayed on the receiving device as a map of a proximate area corresponding to the location data.

6. The method of claim 5, wherein the geographical data comprises a link to a geographical data server wherein at least one of a plurality of characteristics of the proximate area are selected for display within the receiving device.

7. The method of claim 1, wherein the location data comprises graphical content configured to be displayed on the call receiving device as a map that depicts the geographical location as an icon corresponding to the caller identification data.

8. A computer program product, the computer program product comprising a computer usable storage medium having computer-readable program code embodied in the medium, the computer readable program code configured to perform the method of claim 1.

9. A system for enhancing communication services, comprising:
a caller identifier, configured to determine identification data corresponding to an originating device that originates a call to a receiving device and to transmit the identification data to the receiving device; and
a caller locator, configured to determine a geographical location of the originating device and to transmit the geographical location to the receiving device.

10. The system of claim 9, wherein the caller locator is further configured to use Global Positioning System (GPS) data to determine the geographical location.

11. The system of claim 9, wherein the caller locator is further configured to receive the geographical location from the originating device, wherein the geographical location is manually provided in the originating device by a user.

12. The system of claim 9, wherein the caller locator is further configured to receive the geographical location from a communication system configured to determine the geographical location using at least one characteristic of a communication between the originating device and the communication system.

13. The system of claim 9, wherein the geographical location comprises graphical content configured to be displayed on the receiving device as a map that depicts the geographical location as a caller name, a caller telephone number and location data.

14. The system of claim 13, wherein the map comprises feature data corresponding to an area proximate to the geographical location, the feature data comprising roads, routes, and landmarks.

15. The system of claim 14, wherein the map further comprises aerial view data from photographic images.

16. The system of claim 9, further comprising means for storing the geographical location in a call log in the receiving device.

17. A method of enhancing communication services, comprising:
identifying an originating device of a call transmitted to a communication device;
determining a location of the originating device; and
sending, to the communication device, an identification of the originating device and the location of the originating device.

18. The method of claim 17, wherein determining a location comprises receiving the location from the originating device, wherein the originating device is configured to receive positioning signals from a positioning system and determine the location responsive to the positioning signals.

19. The method of claim 17, further comprising sending, to the communication device, geographical location data corresponding to the location, wherein the geographical location data comprises graphical content configured include a map to be displayed by the communication device, wherein the map comprises a plurality of terrestrial features of an area proximate to the location and a position indication corresponding to the location.

20. The method of claim 17, further comprising:
determining a location of the communication device; and
sending the location of the communication device to the originating device.
